(19) United States
(12) Patent Application Publication
(10) Pub. No.: US 2013/0092558 A1
(43) Pub. Date: Apr. 18, 2013

(54) APPARATUS FOR PRODUCING ELECTROLYTIC REDUCED WATER AND CONTROL METHOD THEREOF

(71) Applicant: SAMSUNG ELECTRONICS CO., LTD., Suwon-si (KR)

(72) Inventors: Tae Gyu Kim, Hwaseong-si (KR); Hyun Suk Kwak, Gwangju-si (KR); Young Uk Yun, Suwon-si (KR); Young Chul Ko, Suwon-si (KR)

(73) Assignee: SAMSUNG ELECTRONICS CO., LTD., Suwon-si (KR)

(21) Appl. No.: 13/648,643

(22) Filed: Oct. 10, 2012

(30) Foreign Application Priority Data
Oct. 14, 2011 (KR) 10-2011-0105304

(51) Int. Cl. C25B 15/02; C02F 1/461

(52) U.S. Cl. 205/743; 204/228.6; 204/228.3; 204/228.2

(57) ABSTRACT

An apparatus for producing electrolytic reduced water, the apparatus including a water purifying unit configured to generate purified water by filtering water, an electrolytic reduced water generating unit comprising a first electrode and a second electrode, which have different polarities, configured to receive the purified water through a first pipe connected to the water purifying unit and configured to generate reduced water containing dissolved hydrogen gas by performing electrolysis on the purified water through the first electrode and the second electrode. a control unit configured to determine a point of time for switching polarities of the first electrode and the second electrode based on the detected water quality and to control an operation of the power supply unit such that the polarities of the first electrode and the second electrode are switched if it is determined that the point of time is reached.

### CROSS-REFERENCE TO RELATED APPLICATIONS

This application claims the benefit of Korean Patent Application No. 2011-0105304, filed on Oct. 14, 2011 in the Korean Intellectual Property Office, the disclosure of which is incorporated herein by reference.

### BACKGROUND

1. Field

Embodiments of the present disclosure relate to an apparatus for producing electrolytic reduced water and a control method thereof, capable of providing electrolytic reduced water having a superior reducing power with a high concentration of dissolved hydrogen while maintaining a neutralized state.

2. Description of the Related Art

With economic growth, a water market has been growing, and a consumer takes and drinks water in diversified ways.

For example, drinking water can be acquired by taking natural spring water, boiling tap water, purifying through a water purifier, or creating water through an alkaline ionized water creator.

The purifier creates neutralized water (pH 5.8 to 8.5) having a 70% to 90% reduced level of turbidity, germs, viruses, organic compounds, agricultural chemicals, heavy metals, disinfected byproducts, and inorganic ions by use of at least one filter including a Reverse Osmosis (RO) filter.

The water coming out of the purifier only serves to keep the metabolism in a living thing and relieve one's thirst. However, the water does not have a function related to an Oxidation Reduction Potential (ORP) that indicates benefits to health.

In order to compensate for constraints of the purifier and add functionality beneficial to health, an alkaline ionized water creator has been developed.

The alkaline ionized water creator is medical equipment configured to produce water of pH 8.5 or above, and the alkaline ionized water is approved by the Korean Food & Drug Administration as having desirable effects on four major gastroenteric troubles, including a chronic diarrhea, indigestion, and abnormal fermentation in the intestines, and is also generally approved in the medical community as having desirable effects on various diseases, including intestinal diseases, blood system diseases, diabetes, and atopic dermatitis.

It is proven that such a beneficial effect is caused by a small quantity of hydrogen gas existing in water, as has been published through relevant societies and reports.

In order to increase the concentration of hydrogen gas corresponding to the reducing power in alkaline ionized water, a high level of voltage and current needs to be applied to an electrode in an alkaline ionized water creator during electrolysis.

However, such a high level of voltage and current does not only increase the reducing power, but also the hydrogen ion concentration (pH).

### SUMMARY

Therefore, it is an aspect of the present disclosure to provide an apparatus for producing electrolytic reduced water and a control method thereof, capable of extending a lifetime of a cation exchange resin used to produce electrolytic reduced water, maintaining the neutralized state (pH), and producing electrolytic reduced water having a superior reducing power by converting polarities of two electrodes, which are configured to achieve an electrolysis when producing electrolytic reduced water, based on a water quality of electrolytic reduced water.

It is another aspect of the present disclosure to provide an apparatus for producing electrolytic reduced water and a control method thereof, capable of extending a lifetime of a cation exchange resin used to produce electrolytic reduced water, maintaining the neutralized state (pH), and producing electrolytic reduced water having a superior reducing power by converting polarities of two electrodes, which are configured to achieve an electrolysis when producing electrolytic reduced water, based on a flow rate of purified water that is used to produce electrolytic reduced water.

It is another aspect of the present disclosure to provide an apparatus for producing electrolytic reduced water and a control method thereof, capable of maintaining the neutralized state (pH) and capable of regenerating an electrolytic reduced water having a superior reducing power by controlling the operation of a circulation unit based on a water quality of electrolytic reduced water that is stored in a water storage unit such that electrolytic reduced water of the water storage unit is transferred to an electrolytic reduced water generating unit

Additional aspects of the disclosure will be set forth in part in the description which follows and, in part, will be apparent from the description, or may be learned by practice of the disclosure.

In accordance with one aspect of the present disclosure, an apparatus for producing electrolytic reduced water includes a water purifying unit, an electrolytic reduced water generating unit, a water storage unit, a power supply unit, a water quality detecting unit and a control unit. The water purifying unit is configured to generate purified water by filtering water. The electrolytic reduced water generating unit includes a first electrode and a second electrode, which have different polarities. The electrolytic reduced water generating unit is configured to receive the purified water through a first pipe connected to the water purifying unit and to generate reduced water containing dissolved hydrogen gas by performing electrolysis on the purified water through the first electrode and the second electrode. The water storage unit is configured to receive the reduced water through a second pipe connected to the electrolytic reduced water generating unit and to store the received electrolytic reduced water. The power supply unit is configured to apply a different polarity of electricity to each of the first electrode and the second electrode. The water quality detecting unit is configured to detect a water quality of the reduced water. The control unit is configured to determine a point of time for switching polarities of the first electrode and the second electrode based on the detected water quality and to control an operation of the power supply unit such that the polarities of the first electrode and the second electrode are switched if it is determined that the point of time is reached.

The detecting unit includes a hydrogen potential (pH) detecting unit configured to detect a hydrogen ion concentration of the reduced water and an oxidation reduction potential (ORP) detecting unit configured to detect an oxidation reduction potential of the reduced water. The control unit controls the switching of the polarities of the first electrode and the second electrode.

The electrolytic reduced water generating unit an electrolytic cell, an ion exchange resin, a first cation exchange membrane and a second cation exchange membrane. The electrolytic cell accommodates the first electrode and the second electrode therein and includes an interior space divided into a first chamber and a second chamber by the first electrode and the second electrode. The ion exchange resin is disposed between the first electrode and the second electrode, and configured to elute hydrogen ions to one chamber of the first chamber and the second chamber, the one chamber generating reduced water. The first cation exchange membrane is disposed between the first electrode and the ion exchange resin and carries a hydrogen ion generated from the first chamber if the second chamber generates reduced water. The second cation exchange membrane is disposed between the second electrode and the ion exchange resin and carries a hydrogen ion generated from the second chamber if the first chamber generates reduced water.

The first pipe includes passages that are each formed between the water purifying unit and the first chamber, the water purifying unit and the second chamber, and the water purifying unit and the ion exchange resin. A first valve is provided to close a passage connected to at least one of the first chamber and the second chamber among the passages. The control unit controls the operation of the first valve such that the passage connected to the at least one of the first chamber and the second chamber is closed based on the water quality.

The apparatus further includes a first water flow rate detecting unit configured to detect a flow rate of purified water discharged from the water purifying unit. Based on the flow rate detected from the first water flow rate detecting unit, the control unit controls the operation of the power supply unit such that the polarities of the first electrode and the second electrode are switched, and controls the first valve such that the passage closing is switched between the passages.

The apparatus further includes a water level detecting unit configured to detect a water level of the water storage unit. Based on the water level detected from the water level detecting unit, the control unit controls operation/non-operation of the power supply unit such that the generating of the reduced water is regulated, and controls a first valve such that the passages connected to the first chamber and to the second chamber are closed.

The apparatus further includes a voltage detecting unit configured to detect voltages of the first electrode and the second electrode. The control unit controls the power supply unit such that a constant current is applied to the first electrode and to the second electrode, and controls the operation of the power supply unit such that the polarities of the first electrode and the second electrode are switched based on the detected voltage.

The apparatus further includes a second valve provided between the water purifying unit and the electrolytic reduced water generating unit. The control unit controls an operation of the second valve such that a constant flow rate of purified water is provided from the water purifying unit to the electrolytic reduced water generating unit.

The apparatus further includes a second water flow rate detecting unit provided between the second valve and the electrolytic reduced water generating unit to detect a flow rate of water provided to the electrolytic reduced water generating unit at the second valve. The control unit controls the operation of the second valve based on the flow rate detected through the second flow rate detecting unit.

The control unit adjusts a magnitude of electric current output from the power supply unit based on the flow rate detected through the second water flow rate detecting unit.

The apparatus further includes an electric current detecting unit configured to detect an electric current flowing between the first electrode and the second electrode. The control unit controls the power supply unit such that a constant voltage is applied to the first electrode and the second electrode, and controls a pulse-width modulation of the constant voltage based on the detected electric current.

The apparatus further includes a third pipe and a third valve provided on the third pipe. The third pipe is connected to the water storage unit and is configured to guide a stream of the reduced water to outside such that the reduced water of the water storage unit is discharged to outside. The control unit controls an openness of the third valve based on the water quality of the reduced water.

The apparatus further includes a circulation unit provided between the water storage unit and the electrolytic reduced water generating unit. Based on a water quality of reduced water, the control unit controls an operation of the circulation unit such that reduced water of the water storage unit is provided to the electrolytic reduced water generating unit.

The circulation unit includes a fourth pipe, a fourth valve and a pump. The fourth pipe is connected between the water storage unit and the electrolytic reduced water generating unit. The fourth valve is provided on the fourth pipe and configured to be open based on a command of the control unit. The pump is provided between the fourth valve and the water storage unit to pump reduced water of the water storage unit based on a command of the control unit.

In accordance with another aspect of the present disclosure, an apparatus for producing electrolytic reduced water includes a water purifying unit, an electrolytic reduced water generating unit, a water storage unit, a power supply unit, a flow rate detecting unit and a control unit. The water purifying unit is configured to generate purified water by filtering water. The electrolytic reduced water generating unit includes a first electrode and a second electrode that have different polarities, and is configured to generate reduced water containing a dissolved hydrogen gas by performing electrolysis on the purified water through the first electrode and the second electrode. The water storage unit is configured to store the received electrolytic reduced water. The power supply unit is configured to apply a different polarity of electricity to each of the first electrode and the second electrode. The flow rate detecting unit is configured to detect a flow rate of purified water discharged from the water purifying unit. The control unit is configured to determine a point of time for switching polarities of the first electrode and the second electrode based on the flow rate of purified water. The control unit is configured, if it is determined that the points of time for switching the polarities of the first electrode and the second electrode is reached, to control an operation of the power supply unit such that the polarities of the first electrode and the second electrode are switched.

The apparatus further includes a voltage detecting unit configured to detect voltages of the first electrode and the second electrode. The control unit controls the power supply unit such that a constant current is applied to the first electrode and the second electrode, controls the operation of the power supply unit such that the polarities of the first electrode and the second electrode are switched based on the detected voltage, and adjusts a magnitude of electric current output from the power supply unit based on the detected flow rate.

The electrolytic reduced water generating unit includes an electrolytic cell, an ion exchange resin, a first cation exchange membrane and a second cation exchange membrane. The electrolytic cell accommodates the first electrode and the second electrode therein and includes an interior space divided into a first chamber and a second chamber by the first electrode and the second electrode. The ion exchange resin is disposed between the first electrode and the second electrode to elute hydrogen ions to one chamber of the first chamber and the second chamber, the one chamber generating reduced water. The first cation exchange membrane, is disposed between the first electrode and the ion exchange resin, and carries a hydrogen ion generated from the first chamber if the second chamber generates reduced water. The second cation exchange membrane is disposed between the second electrode and the ion exchange resin, and carries a hydrogen ion generated from the second chamber if the first chamber generates reduced water.

The apparatus further includes a first pipe and a first valve. The first pipe includes a first passage connected to the water purifying unit, a second passage provided between the first passage and the first chamber, a third passage provided between the first passage and the second chamber, and a fourth passage provided between the first passage and the ion exchange resin. The first valve is configured to open at least one of the second passage and the third passage. Based on the detected flow rate, the control unit controls an operation of the first valve such that the passage opening is switched between the passages.

The apparatus further includes a first flow rate control valve provided on at least one of the second passage and the third passage, and a second flow rate control vale provided on the fourth passage. The control unit controls opening degrees of the first and the second flow rate control valves based on the detected flow rate.

In accordance with another aspect of the present disclosure, an apparatus for producing electrolytic reduced water includes a water purifying unit, an electrolytic reduced water generating unit, a water storage unit, a power supply unit, a water level detecting unit, a water quality detecting unit, a circulation unit and a control unit. The water purifying unit is configured to generate purified water by filtering water. The electrolytic reduced water generating unit includes a first electrode and a second electrode, which have different polarities, and is configured to generate reduced water containing dissolved hydrogen gas by performing electrolysis on the purified water through the first electrode and the second electrode. The water storage unit is configured to store the reduced water. The power supply unit is configured to apply a different polarity of electricity to each of the first electrode and the second electrode. The water level detecting unit is configured to detect a water level of water stored in the water storage unit. The water quality detecting unit is configured to detect a water quality of the reduced water. The circulation unit is provided between the electrolytic reduced water generating unit and the water storage unit. The control unit is configured to control an operation of the power supply unit such that an electrolysis is performed in the electrolytic reduced water generating unit if the water level of the water storage unit is below a reference water level, and to control an operation of the circulation unit such that the reduced water of the water storage unit is delivered to the electrolytic reduced water generating unit based on the water quality if the water level of the water storage unit exceeds the reference water level.

The circulation unit includes a circulation pipe, a divert valve and a pump. The circulation pipe is connected between the water storage unit and the electrolytic reduced water generating unit. The divert valve is provided on the circulation pipe. The pump is provided between the divert valve and the water storage unit to pump the reduced water of the water storage unit such that the reduced water of the water storage unit is supplied to the electrolytic reduced water generating unit.

The water quality detecting unit includes an oxidation reduction potential (ORP) detecting unit configured to detect an oxidation reduction potential of the reduced water. The control unit controls an openness of the divert valve such that the reduced water of the water storage unit is recycled if the detected ORP exceeds a reference level of ORP.

In accordance with one aspect of the present disclosure, a method of controlling an apparatus for producing electrolytic reduced water is as follows.

Purified water is generated by filtering water. Electrolysis is performed on the purified water by applying different polarities of electricity to a first electrode and a second electrode, respectively. Reduced water, which is generated through the electrolysis, is stored in a water storage unit. A water quality of the reduced water stored in the water storage unit is detected. A point of time for switching polarities of electricity applied to the first electrode and the second electrode is determined based on the water quality. If it is determined that the point of time for switching the polarities of electricity is reached, the polarities of electricity applied to the first electrode and the second electrode are switched by controlling an operation of a power supply unit.

The performing of the electrolysis is as follows. Some of the purified water is supplied to one of a first chamber and a second chamber on which the first electrode and the second electrode are disposed, respectively. The remaining is supplied to an ion exchange resin disposed between the first electrode and the second electrode.

The supplying of some of the purified water to one of the first chamber and the second chamber is as follows. First, a first valve is controlled. The first valve is configured to open/close passages connected to the first chamber and the second chamber, respectively. A passage of a chamber to generate the reduced water is opened between the first chamber and the second chamber such that the some of the purified water is supplied, and also a passage of a chamber to generate oxygen gas is closed between the first chamber and the second chamber such that the supply of the purified water is blocked.

The method may further include switching a passage opened by the first valve between the passages if it is determined that the point of time for switching the polarities of electricity applied to the first electrode and the second electrode is reached.

The method is further performed as follows. A flow rate of purified water discharged from a water purifying unit is detected. An accumulated total of flow rate is calculated based on the detected flow rate. Polarities of the first electrode and the second electrode are switched if the accumulated total of flow rate exceeds a reference flow rate. A control is performed such that a passage opened by the first value is switched between the passages.

The detecting of the water quality includes detecting at least one data of a hydrogen ion concentration and an oxidation reduction potential (ORP).

The determining of the point of time for switching the polarities of electricity applied to the first electrode and the second electrode based on the water quality includes switching the polarities of the first electrode and the second electrode if the detected hydrogen ion concentration exceeds a reference level of hydrogen ion concentration.

The determining of the point of time for switching the polarities of electricity applied to the first electrode and the second electrode based on the water quality includes switching the polarities of the first electrode and the second electrode if the detected ORP exceeds a reference level of ORP.

The method is further performed as follows. A water level of the reduced water stored in the water storage unit is detected. Stopping of the electrolysis of the purified water is controlled if the detected water level exceeds a reference water level.

The method is further performed as follows. The ORP of the reduced water is detected if the detected water level exceeds the reference water level. A pump provided between an electrolytic reduced water generating unit and the water storage unit is driven if the detected ORP of the reduced water exceeds a reference ORP. A divert valve provided between the pump and the electrolytic reduced water generating unit is open. The reduced water of the water storage unit is received and electrolysis is performed again, thereby recycling reduced water.

The performing of the electrolysis is as follows. A constant electric current is applied to the first electrode and the second electrode. Voltages of the first electrode and the second electrode are detected. Switching of the polarities of the first electrode and the second electrode is controlled if the detected voltage exceeds a reference voltage.

The method is further performed as follows. A flow rate of the purified water is detected. A magnitude of electric current applied to the first electrode and the second electrode is controlled based on the detected flow rate.

The performing of the electrolysis is as follows. A constant electric voltage is applied to the first electrode and the second electrode. An electric current flowing between the first electrode and the second electrode is detected. A pulse-width modulation of the constant electric voltage is controlled if the detected electric current is below a reference electric current.

The method is further performed as follows. A water level of the reduced water stored in the water storage unit is detected. The ORP of the reduced water is detected if the detected water level exceeds a predetermined reference water level. A valve, which is connected to the water storage unit, is open to discharge the reduced water of the water storage unit to outside if the detected ORP of the reduced water exceeds a predetermined ORP that is designated in advance.

As described above, the present disclosure can provide electrolytic reduced water having an improved reducing power while maintaining a neutral state (pH 5.8 to 8.5).

That is, the present disclosure can maximize the amount of dissolved hydrogen gas in water at room temperature, facilitate activated reduced water having a small cluster of water molecules for health, beauty and crop cultivation, and further provide a use across a purifier market and a medical equipment market.

In addition, the present disclosure can transfer electrolytic reduced water of a reference reducing power or below in a water storage unit to an electrolytic reduced water generating unit to recycle the electrolytic reduced water having a low reducing power into electrolytic reduced water having a reference reducing power or above, thereby reducing the amount of waste water and maintaining the reducing power of electrolytic reduced water in the water storage unit.

In addition, the lifespan of the ion exchange resin and cation exchange membrane is increased.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating the configuration of an apparatus for producing electrolytic reduced water according to an embodiment of the present disclosure.

FIG. 2 is a view illustrating the configuration of an electrolytic reduced water generating unit of the electrolytic reduced water producing apparatus according to the embodiment of the present disclosure.

FIGS. 3A and 3B are views showing the ion exchange of an ion exchange resin provided in the electrolytic reduced water generating unit of the electrolytic reduced water producing apparatus according to the embodiment of the present disclosure.

FIG. 4 is a view showing an oxidation reduction potential graph according to hydrogen dissolved in reduced water that is generated from the electrolytic reduced water producing apparatus according to the embodiment of the present disclosure.

FIG. 5 is a graph showing the difference in the pH and ORP characteristic between water from a conventional alkaline ionized water creator and water from the electrolytic reduced water producing apparatus according to the embodiment of the present disclosure.

FIG. 6 is a graph showing the ORP according to the flow rate and the electric current applied to the electrolytic reduced water producing apparatus according to the embodiment of the present disclosure.

FIG. 7 is a control block diagram illustrating the electrolytic reduced water producing apparatus according to the embodiment of the present disclosure.

FIG. 8 is a view illustrating the regeneration of an ion exchange resin provided in the electrolytic reduced water producing apparatus according to the embodiment of the present disclosure.

FIG. 9A is a graph showing the change in electrical resistance according to the flow rate in an electrolytic cell of the electrolytic reduced water producing apparatus according to the embodiment of the present disclosure.

FIG. 9B is a graph showing the change in electrical voltage according to the flow rate in an electrolytic cell of the electrolytic reduced water producing apparatus according to the embodiment of the present disclosure

FIG. 10 is a graph showing the change in potential of hydrogen (pH) with the switching of electrode polarities in a water storage unit of the electrolytic reduced water producing apparatus according to the embodiment of the present disclosure.

FIG. 11 is a graph showing the relationship between duration time and the reducing power of reduced water stored in the water storage unit of the electrolytic reduced water producing apparatus according to the embodiment of the present disclosure.

FIG. 12 is a flowchart showing the operation of the electrolytic reduced water producing apparatus according to the embodiment of the present disclosure.

FIG. 13 is a view illustrating the configuration of an apparatus for producing electrolytic reduced water according to another embodiment of the present disclosure.

FIG. 14 is a control block diagram illustrating the electrolytic reduced water producing apparatus according to another embodiment of the present disclosure.

FIG. 15 is a flowchart showing the operation of the electrolytic reduced water producing apparatus according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

An apparatus for producing electrolytic reduced water according to the embodiment of the present disclosure adopts benefits of a water purifier and an alkaline ionizer, in which the water purifying unit removes all of heavy metals, organic substances, and inorganic ions, and produces pure water that does not have a reducing power while the alkaline ionizer removes only free chlorine residual, turbidity, chromaticity, and chloroform, and produces alkaline water of pH 8.5 or above that only satisfies the basic level of purified water. Accordingly, the apparatus for producing electrolytic reduced water according to the embodiment of the present disclosure produces clean and safe water that takes on neutrality with pH 5.8 to 8.5, lacks microorganisms, germs, chlorine residual, heavy metals, organic compounds, and pesticide, and adds a reducing power.

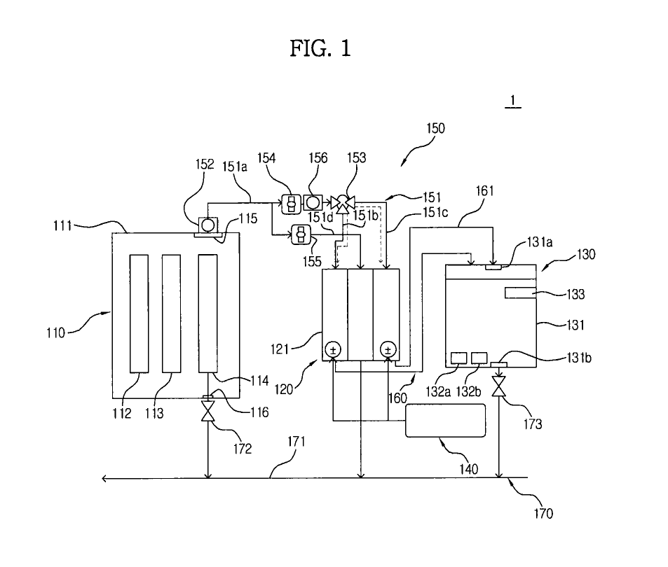

FIG. 1 is a view illustrating the configuration of an apparatus 1 for producing electrolytic reduced water according to an embodiment of the present disclosure. The apparatus 1 includes a water purifying unit 110, an electrolytic reduced water generating unit 120, a water storage unit 130, and a power supply unit 140.

The water purifying unit 110 filters water, that is, source water, introduced from outside, to generate purified water.

The water purifying unit 110 includes a water purifying cell 111 having a purifying space and a plurality of filters 112, 113, and 114 that are spaced apart from one another in the water purifying space.

The plurality of filters 112, 113, and 114 include a sediment filter 112, a Pre-carbon filter 113, and a Reverse Osmosis filter (RO filter) 114. The sediment filter 112 makes contact with the source water in the beginning to remove dust, dregs, contamination substances, and other particles having a particle size of 0.5 micron or above. The Pre-carbon filter 113 includes aero thermal treated carbon, and adsorbs toxic chemicals and organic chemical substances dissolved in the source water. The RO filter 114 removes free chlorine residual, chromaticity, turbidity, chloroform, microorganisms, and germs from the source water, and in addition, removes organic compounds, pesticides, heavy metals, and inorganic ion components through a special purifying capacity, thereby only passing pure water.

Hereinafter, the pure water passing through the RO filter 114 will be referred to as purified water.

The configuration of the water purifying unit 110 is not limited thereto. The water purifying unit 110 may include only one filter.

Alternatively, the water purifying unit 110 may further include another filter in addition to a sediment filter, a Pre-carbon filter, and a RO filter.

The water purifying unit 110 includes a first discharge port 115 configured to discharge water, which is purified through the ROF filter 114, and a first waste water port 116 configured to discharge waste water containing impurities that fail to pass through the filter.

The electrolytic reduced water generating unit 120 generates reduced water by performing electrolysis on the purified water, which is supplied from the water purifying unit 110. The reduced water represents water, which contains hydrogen gas while taking on neutrality of pH of 5.8 to 8.5, and has an Oxidation Reduction Potential (ORP) of about −500 mV.

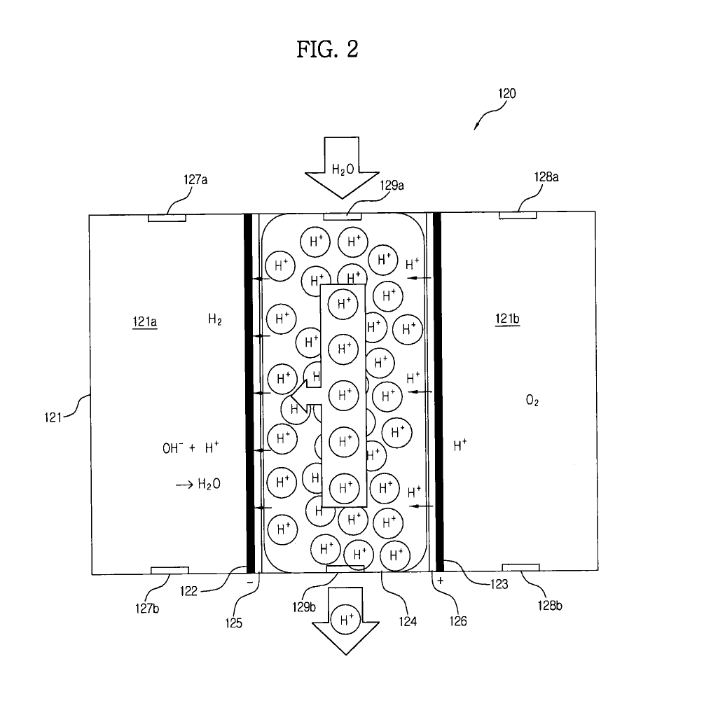

Hereinafter, the structure of the electrolytic reduced water generating unit 120 will be described with reference to FIG. 2.

Referring to FIG. 2, the electrolytic reduced water generating unit 120 includes an electrolytic cell 121 having an electrolytic space where electrolysis occurs, a first electrode 122, a second electrode 123, an ion exchange resin 124, a first cation exchange membrane 125, and a second cation exchange membrane 126. The first electrode 122 and the second electrode 123 are spaced apart from each other. The ion exchange resin 124 is disposed between the first electrode 122 and the second electrode 123 while coming into close contact with the electrolytic cell. The first cation exchange membrane 125 is disposed between the first electrode 122 and the ion exchange resin 124. The second cation exchange membrane 126 is disposed between the second electrode 123 and the ion exchange resin 124.

The electrolytic space of the electrolytic cell 121 is divided into two spaces by the first electrode 122 and the second electrode 123. The two spaces are referred to as a first chamber 121a having a first electrode 122, and a second chamber 121b having a second electrode 123, respectively.

The first chamber 121a includes a first inflow port 127a to receive purified water and a first outflow port 127b to discharge reduced water. The second chamber 121b includes a second inflow port 128a to receive purified water and a second outflow port 128b to discharge reduced water.

A wall provided with the ion exchange resin 124 among all of walls forming the electrolytic cell 121 includes a third inflow port 129a to receive purified water and a third outflow port 129b to discharge reduced water.

Hereinafter, the configuration of the electrolytic reduced water generating unit 120 will be described in detail.

Each of the first electrode 122 and the second electrode 123 is given a different polarity of electricity from each other, and is configured to decompose water through electrolysis.

That is, a negative pole of electricity and a positive pole of electricity are applied to the first electrode 122 and to the second electrode 123, respectively, such that the first electrode 122 and the second electrode 123 serve a cathode and an anode, respectively. Alternatively, a positive pole of electricity and a negative pole of electricity are applied to the first electrode 122 and the second electrode 123, respectively, such that the first electrode 122 and the second electrode 123 serve an anode and a cathode, respectively

The first electrode 122 and the second electrode 123 are laterally disposed while symmetric to each other about the center of the ion exchange resin 124.

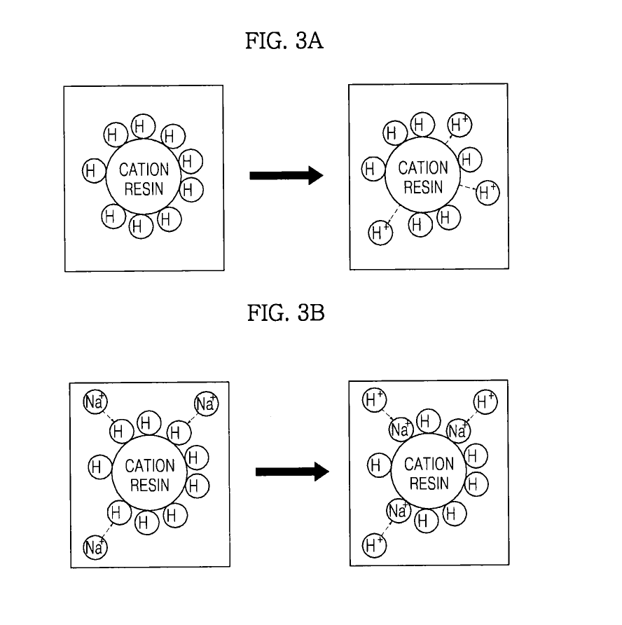

The ion exchange resin 124 according to the embodiment of the present disclosure is implemented using a hydrogen ion (H⁺) type cation exchange resin. Such a hydrogen ion (H⁺) type cation exchange resin will be described with reference to FIG. 3.

Referring to FIG. 3A, the cation exchange resin represents a resin having a SO₃H exchanger attached to a matrix surface thereof. If the cation exchange resin begins to be filled with water, a hydrogen ion (H⁺) is naturally dissociated from the cation exchange resin. That is, hydrogen ions of the cation exchange resin are continuously separated from the matrix while acidifying water to reach equilibrium with hydrogen ions of water.

Referring to FIG. 3B, if a hardness ion having a great electric charge, for example, Na⁺, Mg⁺², and Ca⁺², is introduced, the cation exchange resin separates the hydrogen ion (H⁺) from the matrix surface by substituting the hydrogen ion (H⁺) with the hardness ion.

Some of the hydrogen ions separated in this manner are transferred to a chamber having a cathode, and the remaining are discharged to outside.

In this case, hydrogen ions (H⁺), which are generated through the electrolysis of an anode, are introduced into the ion exchange resin 123 through the cation exchange membrane at a side of the anode, and the ion exchange resin 124 is partially regenerated by the introduced hydrogen ions.

In order to prevent a hydrogen ion concentration of a portion of the ion exchange resin adjacent to the anode from being higher than a hydrogen ion concentration in equilibrium, the polarities of the first electrode and the second electrode are switched to allow the first electrode and the second electrode to alternately serve as the anode, so that hydrogen ions are evenly distributed in the ion exchange resin.

Each of the first cation exchange membrane 125 and the second exchange membrane 126 serves to generate hydrogen ion between an ion exchange resin and an anode electrode, and to deliver the generated hydrogen ion to the ion exchange resin. The first cation exchange membrane 125 operates when a positive polarity of electricity is applied to the first electrode 122, and the second cation exchange membrane 126 operates when a positive polarity of electricity is applied to the second electrode 123.

Hereinafter, electrolysis of the electrolytic reduced water generating unit 120 and the generating of reduced water through the electrolysis will be described in detail. In addition, the description will be made on the assumption that the first electrode 122 and the second electrode 123 serve as a cathode electrode (a negative electrode) and an anode electrode (a positive electrode), respectively.

Referring to FIG. 2, purified water is provided to the first chamber 121a and the ion exchange resin 124 of the electrolytic cell 121, a negative pole of electricity is applied to the first electrode 122, and a positive pole of electricity is applied to the second electrode 123 to cause electrolysis to occur in the first electrode 122 and the second electrode 123.

The purified water provided to the ion exchange resin 124 wets the second cation exchange membrane 126, which is installed while coming into close contact with the second electrode 123 that serves as an anode, and thus the purified water between the surface of the second cation exchange membrane 126 and the surface of the second electrode 123 is subject to the electrolysis to generate hydrogen ion (H⁺) and oxygen gas (O₂).

The oxygen gas (O₂) has a size of about 3.4□ that is hard to pass through the second cation exchange membrane 126 and move to the first chamber 121a having the cathode, so the oxygen gas (O₂) is discharged to outside through the water introduced to the ion exchange resin 124.

Accordingly, the concentration of oxygen in the ion exchange resin 124 is not increased, thereby preventing the lifespan of the ion exchange resin 124 from being reduced by oxidation. In addition, heat (Q∝W=I²R) is generated through the electrolysis, thereby preventing the lifespan of the first and the second cation exchange membranes 125 and 126 and the ion exchange resin 124 from being reduced.

The electrolysis of the purified water occurring in the first electrode 122 and the second electrode 123 has a following reaction:

Cathode (negative electrode): 2H₂0+2e⁻>H₂+2OH⁻,E⁰=−0.828V

Anode (positive electrode): 4H⁺+O₂+4e⁻>2H₂0,E⁰=+1.229V [Reaction 1]

As described above, hydrogen gas (H₂) and hydroxyl (OH⁻) are generated through the electrolysis of the cathode in the first chamber 121a, and oxygen gas (O₂) and hydrogen ion (H⁺) are generated through the electrolysis of the anode in the second chamber 121b. In this case, the hydrogen gas in the first chamber dissolves in the water, and the water having dissolved hydrogen gas has a reducing power.

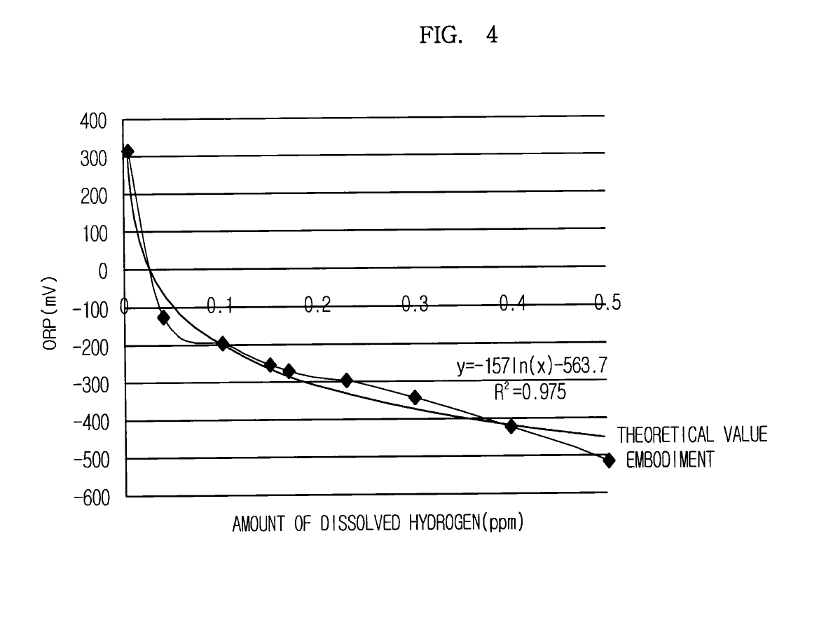

Referring to FIG. 4, a theoretical representation of the oxidation reduction potential with the amount of dissolved hydrogen is substantially matched to the representation of the oxidation reduction potential with the amount of hydrogen dissolved in reduced water that is generated according to the embodiment of the present disclosure. Accordingly, the relation between the amount of hydrogen gas generated through the electrolysis and the oxidation reduction potential is known.

That is, the electromotive force of oxidation reduction potential (ORP) of reduced water according to the amount of hydrogen gas is expressed through equation 1.

In this case, it is assumed that the electrolysis generates only hydroxyl (OH⁻) and hydrogen gas (H₂).

$$E = 828 - ( \frac{59}{n} ) log ( \frac{{H}_{2 - standard}}{{H}_{2 - cathode} \times {( {OH}^{-} )}^{2}} ) \qquad [ Equation 1 ]$$

In equation 1, n represents the number of reactive electrode, H_{2-standard} represents the concentration of H₂ (mol/L) in a standard hydrogen electrode, H_{2-cathode} represents the concentration of hydrogen gas (mol/L) in a cathode electrode, and OH⁻ represents the concentration of OH⁻.

Since electrons move from the first electrode serving as an indicator electrode to the second electrode serving as a standard hydrogen electrode, the oxidation reduction potential is represented as a negative value and the water dipped with the first electrode has a reducing power.

If a voltage of 2.057 (E=E⁺−E⁻=1.229+0.828) as shown in reaction 1) is applied to the anode, the purified water in the first chamber takes on alkali by hydrogen gas (H²) and hydroxyl (OH⁻), which are generated through the electrolysis of the cathode of the first chamber, and the purified water has a negative value of ORP as shown in equation 1.

In this case, hydrogen ion (H⁺) generated between the second electrode 123, which serves as the anode, and the second cation exchange membrane 126 soaked with purified water is transferred to the first chamber 121a through the ion exchange resin 124 serving as a catalyst. The hydrogen ion (H⁺) transferred to the first chamber 121a experiences a neutralization reaction with the hydroxyl (OH⁻), as shown in following reaction 2, thereby preventing the potential of hydrogen (pH) of reduced water, which is generated through the electrolysis of the first electrode 122, from increasing.

OH⁻(generated from cathode)+H⁺(generated between anode and cation exchange resin)→H₂0(neutral water) [Reaction 2]

That is, since the hydrogen ion (H⁺) generated from the second electrode 123 is coupled to the hydroxyl (OH⁻) generated from the first electrode 122 to form a water molecule, the generating of hydrogen increases and the reducing power of the reduced water is increased, but the hydrogen concentration (pH) does not increase.

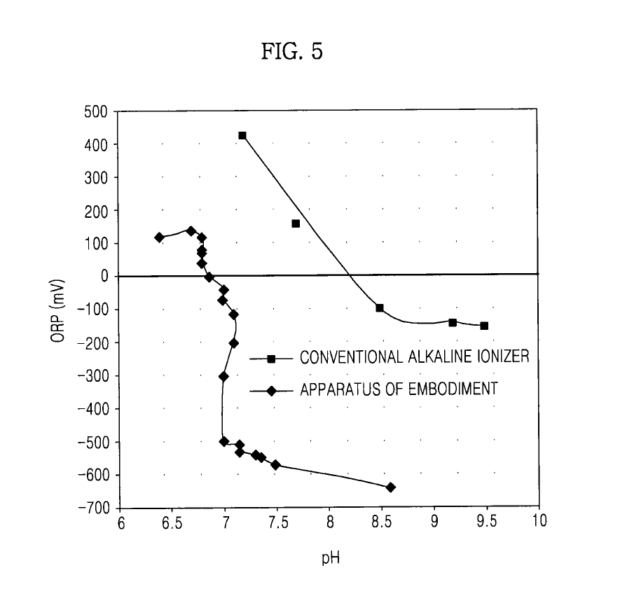

Referring to FIG. 5, according to water produced by the alkaline ionizer, the ORP does not increase beyond −150 mV, and the potential of hydrogen (pH) increases with the increase of electric current.

Meanwhile, according to water produced by the apparatus for producing reduced water of the embodiment of the present disclosure, the ORP increases up to −500 mV, and the potential of hydrogen (pH) has a stable value of about 6.5 to about 8.5.

Accordingly, the water is neutral with a potential of hydrogen (pH) of about 5.8 to 8.5, and has a reducing power corresponding to a negative ORP.

As described above, if the electric polarities of the first and the second electrodes are switched and the first chamber and the second chamber alternately serve as a chamber to receive purified water for generating reduced water, the ion exchange resin serves as a catalyst for transferring hydrogen ion while regenerating its hydrogen ion, and the neutral reduced water is continuously produced.

The water storage unit 130 stores reduced water that is provided from the electrolytic reduced water generating unit 120, and detects the water quality of the reduced water stored in the water storage unit 130 to transmit the water quality to a control unit 191.

The water storage unit 130 includes a water storage cell 131, which is configured to store the reduced water, having a fourth inflow port 131a to receive the reduced water and a fourth outflow port 131b to discharge the reduced water, a water quality detecting unit 132, and a water level detecting unit 133.

The water quality detecting unit 132 includes a hydrogen potential (pH) detecting unit 132a to detect the concentration of hydrogen ions of the reduced water and an oxidation reduction potential (ORP) detecting unit 132b to detect the ORP of the reduced water. The hydrogen potential detecting unit 132a may be integrally formed with the oxidation reduction potential detecting unit 132b.

The power supply unit 140 applies a different polarity of electricity to the first electrode 122 and the second electrode 123, and switches the polarities of electricity applied to the first electrode 122 and the second electrode 123 according to a command of the control unit 191.

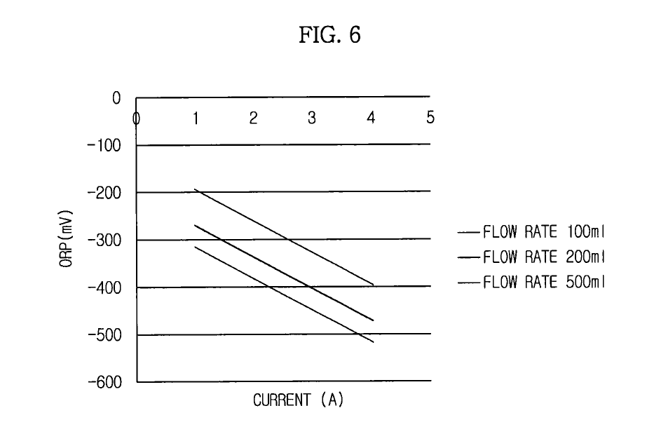

The power supply unit 140 applies a constant current to the first electrode 122 and the second electrode 123 to generate reduced water having a constant reducing power. Hereinafter, the operation of generating reduced water according to application of electric current will be described with reference to equation 2 and FIG. 6.

$$\frac{d {Θ}_{a}}{d t} = \frac{m}{n} \times \frac{1}{F} \times \frac{ C \times l \times w \times N}{d} \times V \qquad [ Equation 2 ]$$

Herein, θₐ represents the amount of generated hydrogen gas (H₂), w represents the width of an electrode, I represents the length of an electrode, a distance of electrodes, V represents a voltage, C represents the conductivity, N represents the number of layered cells, n represents the number of electrodes, m represents the atomic weight, and F represents Faraday constant.

As shown in FIG. 2, the amount of hydrogen gas being generated varies with the change of electric charge relative to time. That is, the amount of generated hydrogen gas varies with the amount of electric current flowing in the electrolytic cell.

In addition, referring to FIG. 6, the oxidation reduction potential increases with the increase of the electric current.

In addition, the power supply unit 140 may apply a constant voltage to the first electrode 122 and the second electrode 123. The power supply unit 140 adjusts the electric current applied to the first electrode 122 and to the second electrode 123 by modulating a pulse-width of the constant voltage according to a command of the control unit 191.

A purified water supply unit 150 includes a first pipe 151, which is configured to supply purified water of the water purifying unit 110 to the electrolytic reduced water generating unit 120, and a first flow rate detecting unit 152, which is configured to detect a flow rate of the purified water discharged from the water purifying unit 110.

The first pipe 151 includes a first passage 151a connected to the first discharge port 115 of the water purifying cell 111, a second passage 151b connected between the first passage 151a and the first inflow port 127a of the electrolytic cell 121, a third passage 151c connected between the first passage 151a and the second inflow port 128a of the electrolytic cell 121, and a fourth passage 151d connected between the first passage 151a and the third inflow port 129a of the electrolytic cell 121.

The fourth passage 151d branches from the first passage 151a, and the third passage 151c branches from the second passage 151b.

A first valve 153 serving as a divert valve is provided at a position where the third passage 151c and the second passage 151b are divided to switch passages. Accordingly, the purified water discharged from the first passage 151a is provided to one of the first chamber 121a and the second chamber 121b according to an opening direction of the first valve 153.

The first valve 153 is implemented using a three-way valve to convert the direction of flow of the purified water.

Accordingly, purified water discharged from the water purifying unit 110 is provided to one of the first and second chambers 121a and 121b and the ion exchange resin 125 according to the operation of the first valve 153.

In addition, an ON/OFF valve may be installed on each of the second passage 151a and the third passage 151b.

The purifying water supply unit 150 may further include a second valve serving as a flow rate control valve configured to control the flow rate of the purified water provided to the first and second chambers 121a and 121b and the ion exchange resin 124.

The second valve includes a first flow rate control valve 154, which is configured to control the flow rate of the purified water provided to the first and the second chambers 121a and 121b, and a second flow rate control valve 155, which is configured to control the flow rate of the purified water provided to the ion exchange resin 124.

The purified water supply unit 150 may further include a second flow rate detecting unit 156 configured to detect the flow rate of the purified water provided to the first and the second chambers 121a and 121b.

The opening degrees of the first flow rate control valve 154 and the second flow rate control valve 155 are adjusted according to the flow rate of the purified water discharged from the water purifying unit 110, thereby adjusting the flow rate of water provided to the chamber to generate the reduced water and the flow rate of the ion exchange resin.

The reduced water supply unit 160 includes a second pipe 161 which serves as a reduced pipe, and is connected to each of the first chamber 121a and the second chamber 121b.

In addition, the reduced water supply unit 160 further includes a valve to open only a passage of the second pipe connected to one of the first chamber 121a and the second chamber 121b which generates the reduced water.

A waste water discharge unit 170 includes the first waste water port 116, a third pipe 171 which is provided at each of the third outflow port 129b of the electrolytic reduced water generating unit and the fourth outflow port 131b of the water storage unit 130, a waste water discharge valve 172 configured to control the discharging of the waste water generated from the water purifying unit 110, and a third valve 173 configured to control the discharging of the reduced water deprived of a reducing power in the water storage unit 130.

The electrolytic reduced water producing apparatus of the present disclosure which has benefits of a water purifier and an alkaline ionizer produces a neutral water (pH 5.8 to 8.5), thereby providing a feasibility of marketing in a water purifier market and an alkaline ionizer market.

In addition, the electrolytic reduced water producing apparatus according to the present disclosure is applied to a dispenser of a refrigerator for houses and shops, or to an indoor humidifier. The water produced by the electrolytic reduced water producing apparatus has a maximum level of dissolved hydrogen at room temperature, and has a small cluster of water molecules that produce a highly activated reduced water suitable for health, beauty care, and crop cultivation.

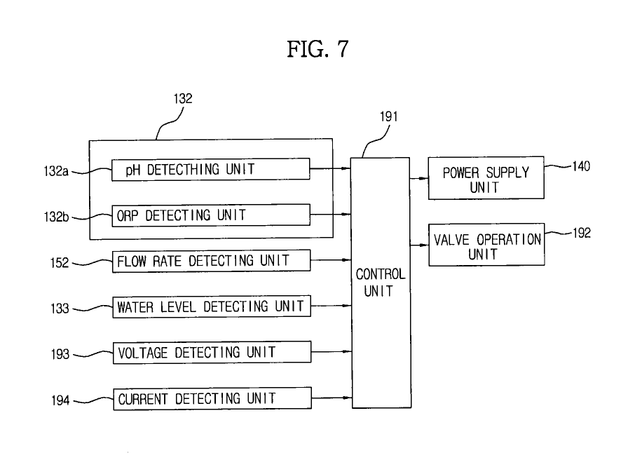

FIG. 7 is a control block diagram illustrating the electrolytic reduced water producing apparatus according to the embodiment of the present disclosure.

The water quality detecting unit 132, which is provided in the water storage cell 131, detects the water quality of the reduced water in the water storage cell 131, and transmits the detected water quality data to the control unit 191.

The water quality detecting unit 132 includes at least one of the hydrogen potential (pH) detecting unit 132a, which detects the concentration of hydrogen ions o the reduced water, and the oxidation reduction potential (ORP) detecting unit 132b, which detects the ORP of the reduced water.

The water level detecting unit 133, which is provided in the water storage cell 131, detects the water level of the reduced water in the water storage cell 131, and transmits the detected water level data to the control unit 191.

The first flow rate detecting unit 152 is provided on the first pipe 151, which is connected to the discharge port of the water storage cell 111. The first flow rate detecting unit 152 detects the flow rate of the purified water discharged from the water purifying cell 111, and transmits the detected flow rate of the purified water to the control unit 191.

The control unit 191 is electrically connected to at least one of the following detecting units, which are, hydrogen potential (pH) detecting unit 132a, the oxidation reduction potential (ORP) detecting unit 132b, the water level detecting unit 133, or the first flow rate detecting unit 152, and receives detection data from the detecting units 132a, 132b, 133, and 152.

In order to maintain the regeneration capacity of the ion exchange resin, the control unit 191 determines the point of time for switching polarities of the first electrode 122 and the second electrode 123 and for switching a passage to receive the purified water, based on the detected data, and performs control such that the polarities of the first and the second electrodes 122 and 123 are switched, and a passage to which the purified water is provided is switched between the passages.

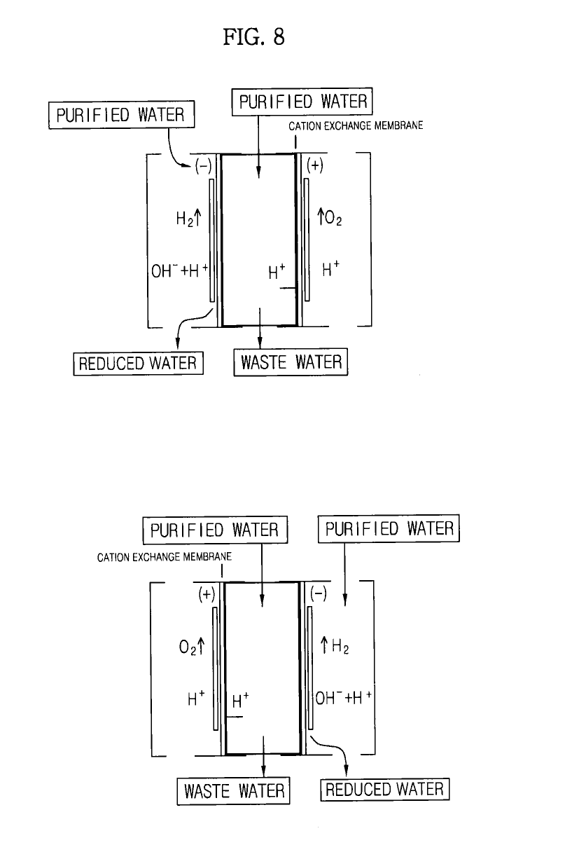

Referring to FIG. 8, the control unit 191 controls the switching of the polarities of the first and the second electrodes and the switching of the passage to receive the purified water such that the first and the second chambers take turn, as a chamber to generate the reduced water and the course of hydrogen ions passing through the ion exchange resin 124 is changed.

In this manner, the regeneration performance of the ion exchange resin 124 is maintained, the reduced water keeps a neutral state of pH and a constant reducing power, and the neutral reduced water is continuously produced. In addition, the ion exchange resin 124 is prevented from being contaminated due to water flowing in one direction.

The control unit 191 determines the point of time for converting a passage to receive the purified water between the passages 151b and 151c based on the data from at least one of the following, which are, the concentration of hydrogen ions of the reduced water stored in the water storage unit 130, the oxidation reduction potential of the reduced water, and the flow rate of the purified water discharged from the water purifying unit 110.

The electrolytic reduced water producing apparatus further includes at least either a voltage detecting unit 193, which is configured to detect an electric voltage applied to the first and the second electrode 122 and 123, or a current detecting unit 194, which is configured to detect an electric current flowing through the first electrode 122 and the second electrode 123.

In an operation through a constant electric current by the power supply unit 140, the control unit 191 controls the power supply unit 140 and a valve operation unit 192 based on the electric voltage detected through the voltage detecting unit 193.

In an operation through a constant electric voltage by the power supply unit 140, the control unit 191 controls the power supply unit 140 and the valve operation unit 192 based on the electric current detected through the current detecting unit 194.

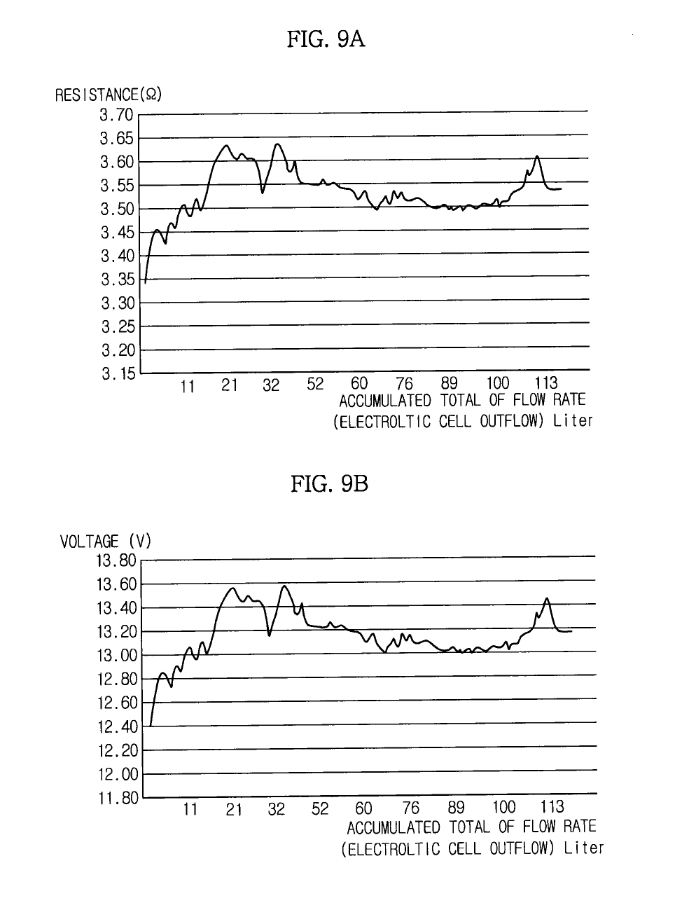

Hereinafter, the operations based on the constant electric current and the constant electric voltage will be described with reference to FIGS. 9A to 11.

FIG. 9A is a graph showing the changes in electrical resistance of an electrolytic cell according to the accumulated total of flow rate that increases with a lapse of time. FIG. 9B is a graph showing the changes in electrical voltage according to electrical resistance in an electrolytic cell. Referring to FIGS. 9A and 9B, when a constant current is applied to the first electrode 122 and the second electrode 123 in the electrolytic cell 121, as the electrolysis proceeds, the first and the second electrodes 122 and 123, the cation exchange membrane, and the ion exchange resin are changed, and thus the electrical resistance and the electrical voltage changes in proportion to an accumulated total of flow rate of the electrolytic cell 121.

In addition, since the electrical resistance changes in proportion to the electrical voltage, if the electrical voltage applied to the first electrode and to the second electrode changes, the electrical resistance is changed, thereby failing to produce reduced water having a constant.

Accordingly, while maintaining the electric current flowing through the first electrode 122 and the second electrode 123 to be constant, the constant current applied to the first electrode 122 and to the second electrode 123 is adjusted based on the changes in voltage of the first and the second electrode 122 and 123 so that a constant electrical resistance of the electrolytic cell is maintained, and thus the reduced water having a constant reducing power is produced.

In this regard, the control unit 191 controls the power supply unit 140 such that a constant current is applied to the first electrode 122 and to the second electrode 123, and the magnitude of the constant current applied to the first and the second electrode is adjusted based on the voltage detected through the voltage detecting unit 193.

Referring to FIG. 6, the amount of hydrogen gas generated when a constant current is applied to the first electrode and to the second electrode is constant. That is, if the accumulated total of flow rate increases with the lapse of time, the amount of hydrogen dissolving in a unit volume is changed, and thus the reducing power is changed.

For the same flow rate, if the electrical current increases, the amount of dissolved hydrogen gas is increased, and thus the reducing power is increased taking on a negative value.

Accordingly, in order to produce the reduced water having a constant reducing power, a constant current is applied to the first and the second electrodes, and the electrolytic cell needs to maintain a constant flow rate.

That is, in order that a constant flow rate of purified water is provided to the electrolytic reduced water generating unit to produce the reduced water having a constant reducing power, the control unit 191 controls the opening degrees of the first flow rate control valve 154 and the second flow rate control valve 155 based on the flow rate of the purified water discharged from the water purified water cell 111, thereby adjusting the flow rate of purified water provided to the ion exchange resin and the chamber to generating the reduced water.

In addition, the control unit 191 adjusts the direction and the magnitude of electric current applied to the electrodes based on the flow rate of the purified water provided to a chamber to generate the reduced water between the first and the second chambers.

In this case, the control unit 191 may control the magnitude of the constant current applied to the first electrode 122 and to the second electrode 123 based on the flow rate detected through one of the first flow rate detecting unit 152 and the second flow rate detecting unit 156.

In addition, the control unit 191 accumulates the flow rates detected through the first flow rate detecting unit 152, and compares the accumulated total of flow rate and controls operation of the power supply unit 140 such that the polarities of electricity applied to the first electrode 122 and the second electrode 123 are switched.

In this manner, the polarities of the electrodes 122 and 123 and the passages are switched by use of the flow rate of the electrolytic cell, thereby maintaining the reducing power and the potential of hydrogen (pH).

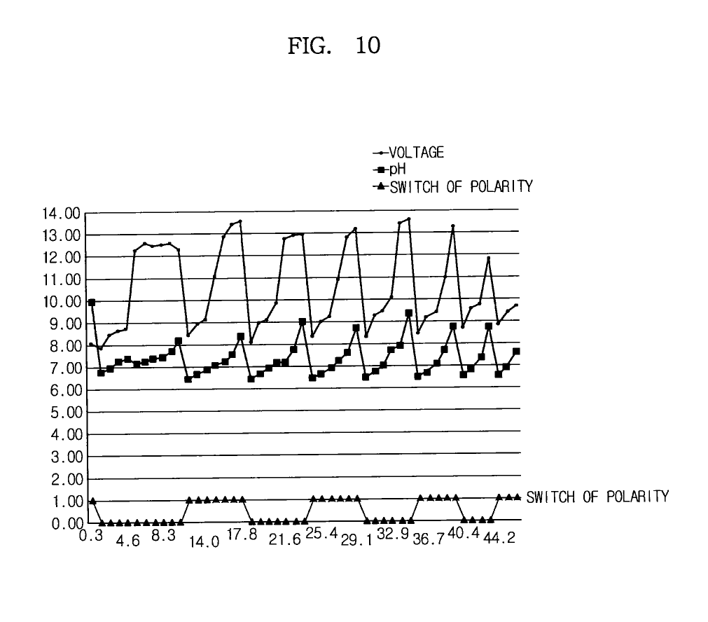

FIG. 10 is a graph showing the changes in potential of hydrogen (pH) of the water storage cell according to the switching of a passage for receiving the purified water and the switching of the polarities of the first and the second electrodes.

The X-axis of FIG. 10 represents the accumulated total of flow rate of the reduced water generated in the electrolytic cell.

Referring to FIG. 10, in a state that the first electrode and the second electrode hold their own polarity, if the accumulated total of flow rate of the purified water introduced to the electrolytic cell increases, the potential of hydrogen (pH) is changed to alkali and the pH neutralization performance is lowered.

Accordingly, when the water storage unit has a hydrogen potential (pH) of 8 or above, the polarities of the first electrode and the second electrode are switched, and a passage to receive the purified water is switched between the passages, so that the pH neutralization performance is maintained.

As described above, the switching the polarities of the first electrode 122 and the second electrode 123 and the switching a passage to receive the purified water which is selected as one of the passages 151b and 151c are performed based on the oxidation reduction potential detected through the oxidation reduction potential detecting unit 132a, thereby maintaining the regeneration performance of the ion exchange resin 124 and maintaining the pH neutralization performance on the reduced water and the reducing power of the reduced water.

That is, the control unit 191 compares the concentration of hydrogen ion detected through the hydrogen potential (pH) detecting unit 132a with a reference hydrogen concentration, controls the operation of the power supply unit 140 such that the polarities of electricity applied to the first and the second electrodes 122 and 123, and controls the valve operation unit 192 such that a passage opening is switched between the passages 151b and 151c through the first valve 153 at the same time of switching the polarities of the first and the second electrode 122 and 123.

In addition, the control unit 191 compares the oxidation reduction potential detected through the operation reduction potential detecting unit 132b with a reference oxidation reduction potential, controls the operation of the power supply unit 140 such that the polarities of electricity applied to the first and the second electrodes 122 and 123, and controls the valve operation unit 192 such that a passage opening is switched between the passages 151b and 151c through the first valve 153 at the same time of switching the polarities of the first and the second electrodes 122 and 123.

As described above, the switching of the polarities of the first and the second electrodes and the switching of the passages of the first pipe 151 are performed based on the oxidation reduction potential detected through the oxidation reduction potential detecting unit 132b, thereby maintaining the regeneration performance of the ion exchange resin 124 and maintaining the pH neutralization performance on the reduced water and the reducing power of the reduced water.

Referring to FIG. 10, in a state that a constant current is applied to the first and the second electrodes 122 and 123, and that the first electrode 122 and the second electrode 123 hold their polarities, if the accumulated total of flow rate increases, the voltage of the first electrode and the second electrode increases.

Meanwhile, when the polarities of the first and the second electrodes are switched and the passages of the first pipe are switched, the voltage of the electrolytic cell is lowered and the potential of hydrogen (pH) becomes neutral.

In this regard, the control unit 191 controls the operation of the power supply unit 140 such that a constant current is applied to the first and the second electrodes 122 and 123, compares the voltage detected through the voltage detecting unit 193 with a reference voltage, controls the operation of the power supply unit 140 such that the polarities of electricity applied to the first and the second electrodes 122 and 123 are switched, and controls the valve operation unit 192 such that a passage opened through the first valve 153 is switched at the same time of the switching of the electricity polarities.

As described above, by switching the electricity polarities and the passages based on the changes in voltage that varies with the accumulated total of flow rate, the reduced water maintains a neutral pH.

In addition, by comparing the water level detected through the water level detecting unit 133 with a reference water level, the control unit 192 determines whether to keep generating the reduced water, and controls the operation/non-operation of the power supply unit 140 based on the result of determination.

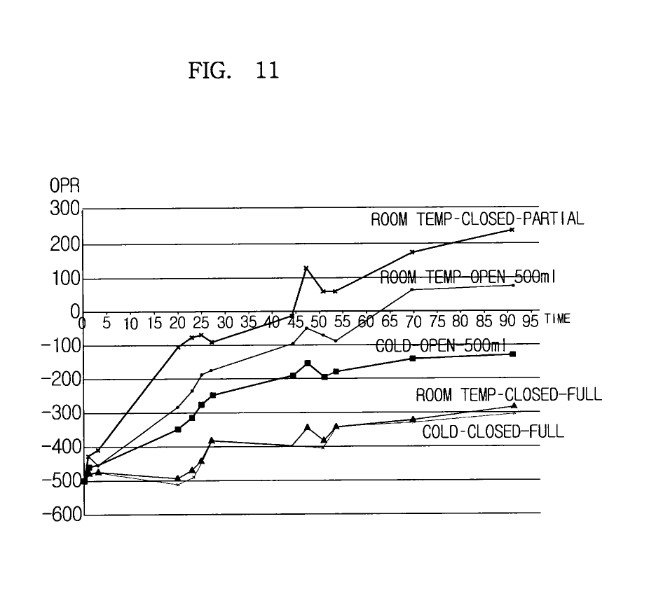

FIG. 11 is a graph showing the changes in the reducing power according to a lapse of time. Referring to FIG. 11, the time taken to lose the reducing power varies in each case of reduced water, but all cases of the reduced water lose with the lapse of time.

In a state that the water level of the reduced water stored in the water storage unit 131 exceeds a reference water level, that is, upon a water storing state, the control unit 191 controls the valve operation unit 192 such that the third valve 173 is open if the oxidation reduction potential of the reduced water is below a predetermined oxidation reduction potential, thereby discharging the reduced water in the water storage unit 131 to the outside.

In addition, the valve operation unit 192 may be controlled such that the third valve 173 is open to discharge the reduced water in the water storage unit 131 to the outside after a predetermined period of time.

When the reduced water is produced by adjusting the constant voltage, the control unit 191 controls the operation of the power supply unit 140 such that the constant voltage is applied to the first and the second electrodes 122 and 123 through the power supply unit 140, compares the current detected through the current detecting unit 194 with a reference current, controls the operation of the power supply unit 140 such that the polarities of electricity applied to the first and the second electrodes 122 and 123 are switched, and controls the valve operation unit 192 such that the passages opened by the first valve 153 are switched at the same time of the switching of the electricity polarities.

In this case, the control unit 191 controls a pulse-width modulation (PWM) of the constant voltage based on the current flowing through the first and the second electrodes 122 and 123 such that a constant current flows through the first and the second electrode 121 and 123. Accordingly, the reduced water having a constant reducing power is generated.

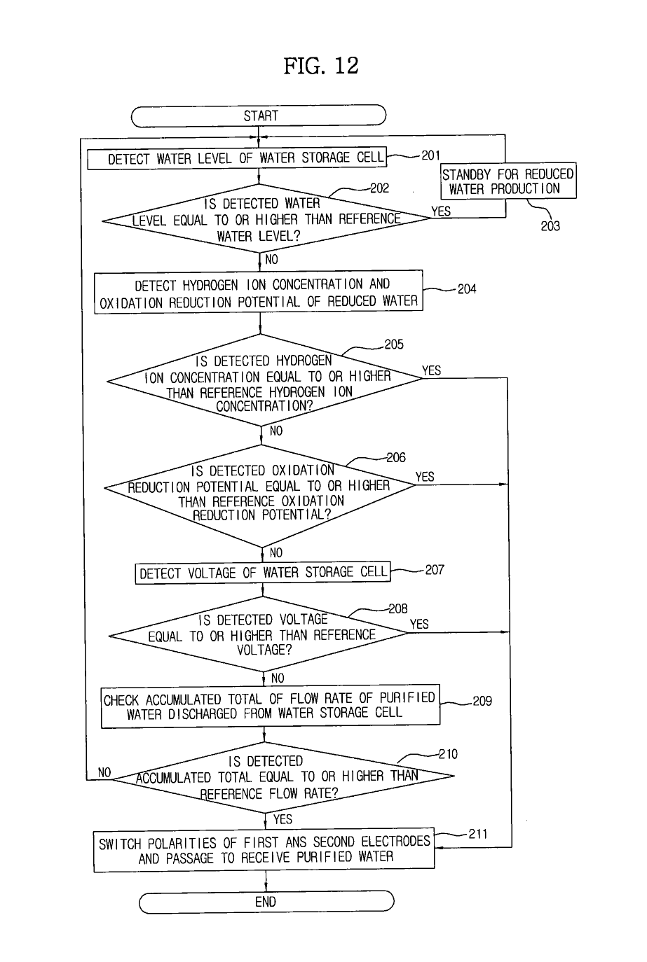

FIG. 12 is a flowchart showing the operation of the electrolytic reduced water producing apparatus according to the embodiment of the present disclosure. Hereinafter, the operation of the electrolytic reduced water producing apparatus will be described in conjunction with FIGS. 1, 2, and 7.

The electrolytic reduced water producing water detects the water level of the reduced water stored in the water storage cell 131 of the water storage unit 130 through the water level detecting unit 133 (201), and compares the detected water level with a reference water level (202).

If the detected water level exceeds the reference water level, the electrolytic reduced water producing apparatus stops producing the reduced water and enters a standby mode (203).

If the detected water level is below the reference water level, the electrolytic reduced water producing apparatus keeps producing the reduced water while performing control such that the polarities of the first and the second electrodes 122 and 123 are switched and the passage opening is switched between passages.

A process of producing the reduced water is as follows.

Water, that is, source water, is provided to the water purifying unit 110 of the electrolytic reduced water producing apparatus, the water purifying unit 110 filters out alienate substance contained in the source water by use of a plurality of filters, and provides the electrolytic reduced water generating unit 120 with the purified water after alienate substance is filtered out through the first pipe 151.

The flow rate of the purified water discharged from the water purifying unit 110 is detected through the first flow rate detecting unit 152 of the electrolytic reduced water producing apparatus. The control unit 191 accumulates and stores the detected flow rate.

In addition, the electrolytic reduced water producing apparatus may further include a storage (not shown) configured to store the detected flow rate of the purified water.

The electrolytic reduced water producing apparatus controls the passage opened by the first valve 153 such that the purified water is provided to the ion exchange resin and to a chamber to generate the reduced water between the first chamber and the second chamber.

For example, if there is a need to generate the reduced water through the first chamber 121a, the electrolytic reduced water producing apparatus controls the first valve 153 such that the first passage 151a is connected to the second passage 151b, and thus the purified water is transferred to the second passage 151b through the first passage 151a that is connected to the water purifying unit 110. At this time, the third passage 151c is closed such that the supply of the purified water of the water purifying unit 110 is blocked.

The electrolytic reduced water producing apparatus applies the constant current to the first and the second electrodes 122 and 123 through the power supply unit 140 such that the first electrode 122 and the second electrode 123 are given a negative pole of electricity and a positive pole of electricity, and thus electrolysis occurs.

If the reduced water is produced from the first chamber 121a through the electrolysis, the first chamber transfers the reduced water to the water storage unit 130 through the second pipe 161.

The water storage unit 130 stores the reduced water, periodically detects the water quality of the reduced water, and determines a point of time for switching the polarities of electricity of the first and the second electrodes 122 and 123 and for switching the passages opened by the first valve 153 based on the detected water quality.

The detecting of the reduced water stored in the water storage cell 131 includes detecting the concentration of hydrogen ions and the oxidation reduction potential of the reduced water stored in the water storage cell 131 (204).

First, the electrolytic reduced water producing apparatus compares the detected concentration of hydrogen ions with a reference concentration of hydrogen ions (205).

If the detected concentration of hydrogen ions exceeds the reference concentration of hydration ions, the electrolytic reduced water producing apparatus determines that the point of time for switching is reached, and therefore switches the polarities of the first and the second electrodes 122 and 123 and switches the passage opened by the first valve 153 (211).

Meanwhile, if the detected concentration of hydrogen ions is below the reference concentration of hydration ions, the electrolytic reduced water producing apparatus compares the detected oxidation reduction potential with a reference oxidation reduction potential (206).

If the detected oxidation reduction potential exceeds the reference oxidation reduction potential, the electrolytic reduced water producing apparatus determines that the point of time for switching is reached, and therefore switches the polarities of the first and the second electrodes 122 and 123 and switches the passage opened by the first valve 153 (211).

Meanwhile, if the detected oxidation reduction potential is below the reference oxidation reduction potential, the electrolytic reduced water producing apparatus detects the voltage applied to the first and the second electrode (207), and compares the detected voltage with a reference voltage (208).

If the detected voltage exceeds the reference voltage, the electrolytic reduced water producing apparatus determines that the point of time for switching is reached, and therefore switches the polarities of the first and the second electrodes 122 and 123 and switches the passage opened by the first valve 153 (211).

Meanwhile, if the detected voltage is below the reference voltage, the electrolytic reduced water producing apparatus checks the accumulated total of flow rate of the purified water discharged through the water purifying unit 110 (209), and compares the accumulated total of flow rate with a reference flow rate (210)

If the accumulated total of flow rate exceeds a reference flow rate, the electrolytic reduced water producing apparatus determines that the point of time for switching is reached, and therefore switches the polarities of the first and the second electrodes 122 and 123 and switches the passage opened by the first valve 153 (211).

Meanwhile, if the accumulated total of flow rate is below the reference flow rate, the electrolytic reduced water producing apparatus keeps generating the reduced water while maintaining each polarity of the first and the second electrodes.

In the standby mode of operation 203, the electrolytic reduced water producing apparatus detects the oxidation reduction potential of the reduced water of the water storage cell 131, and compares the detected oxidation reduction potential with a predetermine oxidation reduction potential. If the detected oxidation reduction potential exceeds the predetermine oxidation reduction potential, the electrolytic reduced water producing apparatus opens the third valve 173 to discharge the reduced water of the water storage cell 131 to the outside.

The electrolytic reduced water producing apparatus may discharge the reduced water of the water storage cell based on the concentration of hydrogen ions.

When the electrolysis is achieved by applying the constant voltage to the first and the second electrodes 122 and 123, the pulse-width modulation of the constant voltage is controlled such that a constant current is provided to the first and the second electrodes. In this case, the electrolytic reduced water producing apparatus detects the current flowing between the first electrode 122 and the second electrode 123, and compares the detected current with a reference current. If the detected current is below the reference current, the polarities of the first and the second electrodes 122 and 123 are switched, and a passage opened by the first valve is switched between the passages.

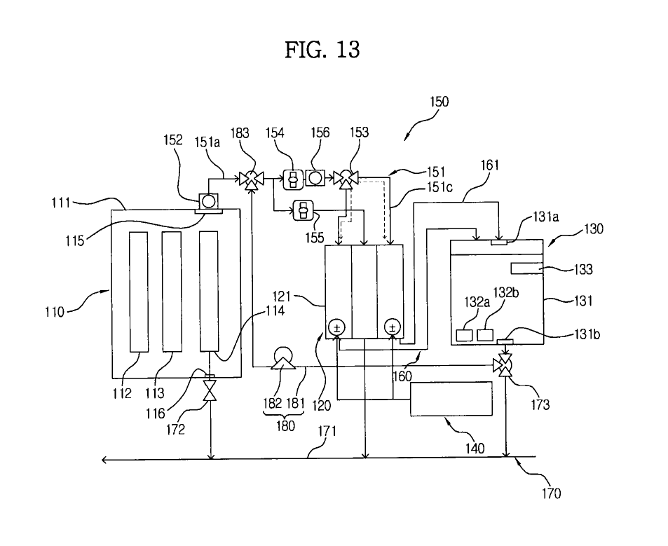

FIG. 13 is a view illustrating the configuration of an apparatus for producing electrolytic reduced water according to another embodiment of the present disclosure that further include a circulation unit 180.

The circulation unit 180 is provided between the water storage unit 130 and the electrolytic reduced water generating unit 120 to supply the reduced water of the water storage unit 130 to the electrolytic reduced water generating unit 120 according to a command of the control unit 191.

The circulation unit 180 includes a fourth pipe 181 provided between the water storage unit 130 and the electrolytic reduced water generating unit 120, a pump 182 provided on the forth pipe 181 to pump the reduced water out of the water storage unit 130, and a fourth valve 183 connected to the fourth pipe 181 and the first pipe 151. The fourth valve 183 is configured to block the passage of the fourth pipe 181 or the passage of the first pipe 151 such that a passage supplying the reduced water to the electrolytic cell is switched.

The fourth valve 183 is implemented using a three-way valve that is configured switch a passage openness according to a command of the control unit 191 such that the purified water of the water purifying unit 110 is provided to the electrolytic reduced water generating unit 120, or the reduced water of the water storage unit 130 is provided to the electrolytic reduced water generating unit 120

In addition, the third valve 173 may be implemented using a three-way valve having an inlet port connected to the water storage cell, an outlet port connected to the waste water pipe 171, and another outlet port connected to the fourth pipe 181.

In this manner, the reduced water of the water storage unit 131 is selectively discarded to outside or circulated as reduced water having a reducing power.

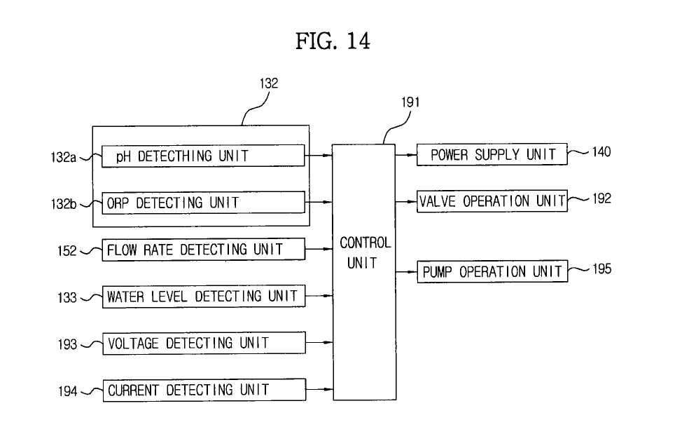

FIG. 14 is a control block diagram illustrating the electrolytic reduced water producing apparatus according to another embodiment of the present disclosure shown in FIG. 13. Different from the previous embodiment, the electrolytic reduced water producing apparatus of FIG. 14 further includes a pump operation unit 195.

In the following description, details of parts identical to those of the previous embodiment will be omitted in order to avoid redundancy.

If a predetermined period of time lapses in a state that the water level exceeds a reference water level or above or the oxidation reduction potential of the reduced water of the water storage cell 131 exceeds a reference oxidation reduction potential, the control unit 191 controls the valve operation unit 192 and the pump operation unit 195.

The valve operation unit 192 switches passages opened by the third valve 173 and the fourth valve 183, and the pump operation unit 195 operates the pump 182 to pump the reduced water out of the water storage unit 131.

In this manner, the fourth outflow port 131b of the water storage cell 131 is connected to the fourth pipe 181 through the third valve 173, and the fourth pipe 181 is connected to the electrolytic reduced water generating unit 120 through the fourth valve 183.

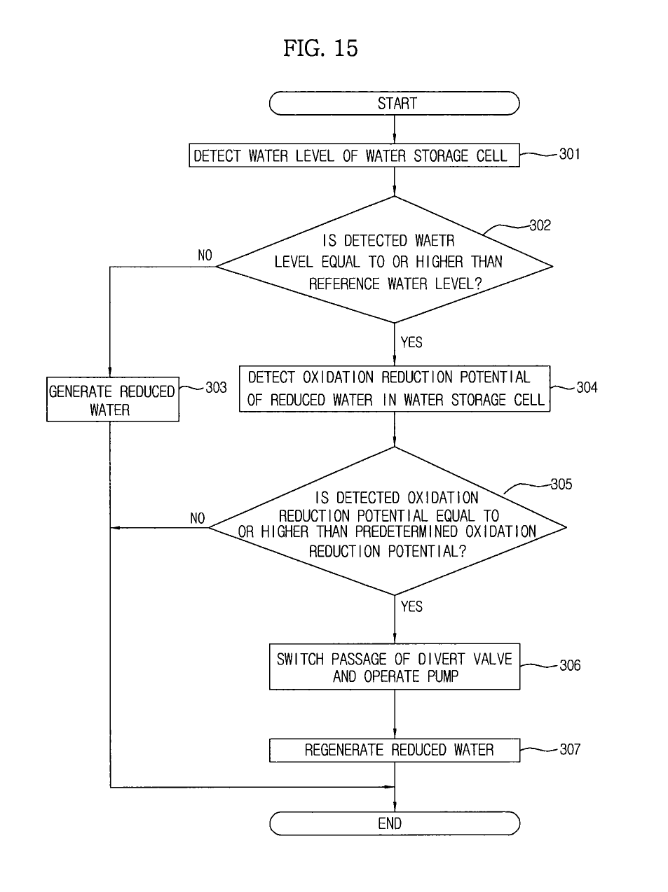

FIG. 15 is a flowchart showing the operation of the electrolytic reduced water producing apparatus according to another embodiment of the present disclosure. The operation of the will be described in conjunction with FIGS. 13 and 15.

The electrolytic reduced water producing apparatus detects the water level of the reduced water stored in the water storage cell 131 of the water storage unit 130 (301), and compares the detected water level with a reference water level (302).

In this case, if the detected water level is below the reference water level, the electrolytic reduced water producing apparatus keeps generating the reduced water (303).

Meanwhile, if the detected water level is equal to or higher than the reference water level, the electrolytic reduced water producing apparatus detects the oxidation reduction potential of the reduced water of the water storage cell (304) and compares the detected oxidation reduction potential with the reference oxidation reduction potential (305).

If the detected oxidation reduction potential is equal to or higher than the reference oxidation reduction potential, the electrolytic reduced water producing apparatus switches passages opened by the third valve 173 and the fourth valve 183, which represents to a divert valve, and operates the pump 182 (306).

In this manner, the reduced water is pumped out of the water storage cell 131 and then discharged to outside through the fourth outflow port 131b of the water storage cell 131. The reduced water discharged is delivered to the fourth pipe 181 of the water storage cell 131 through the third valve 173. Sequentially, the reduced water of the fourth pipe 181 is delivered to the electrolytic reduced water generating unit 120 through the fourth valve 183.

At this time, the fourth valve 183 prevents the purified water of the water purifying unit 110 from being transferred to the electrolytic reduced water generating unit 120.

The electrolytic reduced water generating unit 120 regenerates reduced water having a reducing power below a reference oxidation reduction potential by use of the reduced water that is provided from the water storage cell 131 (307), and transfers the regenerated reduced water to the water storage unit 131.

As described above, the water storage cell to store the reduced water is provided at a rear end of the electrolytic cell, and the pH detecting unit and the ORP detecting unit is provided in the water storage cell. The reduced water in the water storage cell is returned to the electrolytic cell and then subject to the electrolysis according to an output value of the detecting unit, thereby maintaining the reducing power of the reduced water.

In addition, the water in the water storage unit is recycled into the reduced water, thereby reducing the amount of reduced water discarded due to a lack of reducing power.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An apparatus for producing electrolytic reduced water, the apparatus comprising:
a water purifying unit configured to generate purified water by filtering water;
an electrolytic reduced water generating unit comprising a first electrode and a second electrode, which have different polarities, configured to receive the purified water through a first pipe connected to the water purifying unit and configured to generate reduced water containing dissolved hydrogen gas by performing electrolysis on the purified water through the first electrode and the second electrode;
a water storage unit configured to receive the reduced water through a second pipe connected to the electrolytic reduced water generating unit and to store the received electrolytic reduced water;
a power supply unit configured to apply a different polarity of electricity to each of the first electrode and the second electrode;
a water quality detecting unit configured to detect a water quality of the reduced water; and
a control unit configured to determine a point of time for switching polarities of the first electrode and the second electrode based on the detected water quality and to control an operation of the power supply unit such that the polarities of the first electrode and the second electrode are switched if it is determined that the point of time is reached.

2. The apparatus of claim 1, wherein the detecting unit comprises a hydrogen potential (pH) detecting unit configured to detect a hydrogen ion concentration of the reduced water and an oxidation reduction potential (ORP) detecting unit configured to detect an oxidation reduction potential of the reduced water, and
wherein the control unit controls the switching of the polarities of the first electrode and the second electrode.

3. The apparatus of claim 1, wherein the electrolytic reduced water generating unit comprises:
an electrolytic cell, which accommodates the first electrode and the second electrode therein and comprises an interior space divided into a first chamber and a second chamber by the first electrode and the second electrode;
an ion exchange resin which is disposed between the first electrode and the second electrode, and configured to elute hydrogen ions to one chamber of the first chamber and the second chamber, the one chamber generating reduced water;
a first cation exchange membrane which is disposed between the first electrode and the ion exchange resin and carries a hydrogen ion generated from the first chamber if the second chamber generates reduced water; and
a second cation exchange membrane which is disposed between the second electrode and the ion exchange resin and carries a hydrogen ion generated from the second chamber if the first chamber generates reduced water.

4. The apparatus of claim 3, wherein the first pipe includes passages that are each formed between the water purifying unit and the first chamber, the water purifying unit and the second chamber, and the water purifying unit and the ion exchange resin,
wherein a first valve is provided to close a passage connected to at least one of the first chamber and the second chamber among the passages, and
wherein the control unit controls the operation of the first valve such that the passage connected to the at least one of the first chamber and the second chamber is closed based on the water quality.

5. The apparatus of claim 4, further comprising a first water flow rate detecting unit configured to detect a flow rate of purified water discharged from the water purifying unit,
wherein, based on the flow rate detected from the first water flow rate detecting unit, the control unit controls the operation of the power supply unit such that the polarities of the first electrode and the second electrode are switched, and controls the first valve such that the passage closing is switched between the passages.

6. The apparatus of claim 4, further comprising a water level detecting unit configured to detect a water level of the water storage unit,
wherein, based on the water level detected from the water level detecting unit, the control unit controls operation/non-operation of the power supply unit such that the generating of the reduced water is regulated, and controls a first valve such that the passages connected to the first chamber and to the second chamber are closed.

7. The apparatus of claim 1, further comprising a voltage detecting unit configured to detect voltages of the first electrode and the second electrode,
wherein the control unit controls the power supply unit such that a constant current is applied to the first electrode and to the second electrode, and controls the operation of the power supply unit such that the polarities of the first electrode and the second electrode are switched based on the detected voltage.

8. The apparatus of claim 1, further comprising a second valve provided between the water purifying unit and the electrolytic reduced water generating unit,
wherein the control unit controls an operation of the second valve such that a constant flow rate of purified water is provided from the water purifying unit to the electrolytic reduced water generating unit.

9. The apparatus of claim 8, further comprising a second water flow rate detecting unit provided between the second valve and the electrolytic reduced water generating unit to detect a flow rate of water provided to the electrolytic reduced water generating unit at the second valve,
wherein the control unit controls the operation of the second valve based on the flow rate detected through the second flow rate detecting unit.

10. The apparatus of claim 9, wherein the control unit adjusts a magnitude of electric current output from the power supply unit based on the flow rate detected through the second water flow rate detecting unit.

11. The apparatus of claim 1, further comprising an electric current detecting unit configured to detect an electric current flowing between the first electrode and the second electrode,
wherein the control unit controls the power supply unit such that a constant voltage is applied to the first electrode and the second electrode, and controls a pulse-width modulation of the constant voltage based on the detected electric current.

12. The apparatus of claim 1, further comprising:
a third pipe which is connected to the water storage unit and is configured to guide a stream of the reduced water to outside such that the reduced water of the water storage unit is discharged to outside; and
a third valve provided on the third pipe,
wherein the control unit controls an openness of the third valve based on the water quality of the reduced water.

13. The apparatus of claim 1, further comprising a circulation unit provided between the water storage unit and the electrolytic reduced water generating unit,
wherein, based on a water quality of reduced water, the control unit controls an operation of the circulation unit such that reduced water of the water storage unit is provided to the electrolytic reduced water generating unit.

14. The apparatus of claim 13, wherein the circulation unit comprises:
a fourth pipe connected between the water storage unit and the electrolytic reduced water generating unit;
a fourth valve provided on the fourth pipe and configured to be open based on a command of the control unit; and
a pump provided between the fourth valve and the water storage unit and configured to pump reduced water of the water storage unit based on a command of the control unit.

15. An apparatus for producing electrolytic reduced water, the apparatus comprising:
a water purifying unit configured to generate purified water by filtering water;
an electrolytic reduced water generating unit comprising a first electrode and a second electrode that have different polarities, and configured to generate reduced water containing a dissolved hydrogen gas by performing electrolysis on the purified water through the first electrode and the second electrode;
a water storage unit configured to store the received electrolytic reduced water;
a power supply unit configured to apply a different polarity of electricity to each of the first electrode and the second electrode;
a flow rate detecting unit configured to detect a flow rate of purified water discharged from the water purifying unit;
a control unit configured to determine a point of time for switching polarities of the first electrode and the second electrode based on the flow rate of purified water, and configured, if it is determined that the points of time for switching the polarities of the first electrode and the second electrode is reached, to control an operation of the power supply unit such that the polarities of the first electrode and the second electrode are switched.

16. The apparatus of claim 15, further comprising a voltage detecting unit configured to detect voltages of the first electrode and the second electrode,
wherein the control unit controls the power supply unit such that a constant current is applied to the first electrode and the second electrode, controls the operation of the power supply unit such that the polarities of the first electrode and the second electrode are switched based on the detected voltage, and adjusts a magnitude of electric current output from the power supply unit based on the detected flow rate.

17. The apparatus of claim 15, wherein the electrolytic reduced water generating unit comprises:
an electrolytic cell, which accommodates the first electrode and the second electrode therein and comprises an interior space divided into a first chamber and a second chamber by the first electrode and the second electrode;
an ion exchange resin, which is disposed between the first electrode and the second electrode, and is configured to elute hydrogen ions to one chamber of the first chamber and the second chamber, the one chamber generating reduced water;
a first cation exchange membrane, which is disposed between the first electrode and the ion exchange resin, and carries a hydrogen ion generated from the first chamber if the second chamber generates reduced water; and
a second cation exchange membrane, which is disposed between the second electrode and the ion exchange resin, and carries a hydrogen ion generated from the second chamber if the first chamber generates reduced water.

18. The apparatus of claim 17, further comprising:
a first pipe comprising a first passage connected to the water purifying unit, a second passage provided between the first passage and the first chamber, a third passage provided between the first passage and the second chamber, and a fourth passage provided between the first passage and the ion exchange resin; and
a first valve configured to open at least one of the second passage and the third passage,
wherein, based on the detected flow rate, the control unit controls an operation of the first valve such that the passage opening is switched between the passages.

19. The apparatus of claim 17, further comprising a first flow rate control valve provided on at least one of the second passage and the third passage, and a second flow rate control valve provided on the fourth passage,
wherein the control unit controls opening degrees of the first and the second flow rate control valves based on the detected flow rate.

20. An apparatus for producing electrolytic reduced water, the apparatus comprising:
a water purifying unit configured to generate purified water by filtering water
an electrolytic reduced water generating unit comprising a first electrode and a second electrode, which have different polarities, and configured to generate reduced water containing dissolved hydrogen gas by performing electrolysis on the purified water through the first electrode and the second electrode;
a water storage unit configured to store the reduced water;
a power supply unit configured to apply a different polarity of electricity to each of the first electrode and the second electrode;
a water level detecting unit configured to detect a water level of water stored in the water storage unit;
a water quality detecting unit configured to detect a water quality of the reduced water;
a circulation unit provided between the electrolytic reduced water generating unit and the water storage unit; and
a control unit configured to control an operation of the power supply unit such that an electrolysis is performed in the electrolytic reduced water generating unit if the water level of the water storage unit is below a reference water level, and to control an operation of the circulation unit such that the reduced water of the water storage unit is delivered to the electrolytic reduced water generating unit based on the water quality if the water level of the water storage unit exceeds the reference water level.

21. The apparatus of claim 20, wherein the circulation unit comprises a circulation pipe connected between the water storage unit and the electrolytic reduced water generating unit;
a divert valve provided on the circulation pipe; and
a pump provided between the divert valve and the water storage unit to pump the reduced water of the water storage unit such that the reduced water of the water storage unit is supplied to the electrolytic reduced water generating unit.

22. The apparatus of claim 21, wherein the water quality detecting unit comprises an oxidation reduction potential (ORP) detecting unit configured to detect an oxidation reduction potential of the reduced water,
wherein the control unit controls an openness of the divert valve such that the reduced water of the water storage unit is recycled if the detected ORP exceeds a reference level of ORP.

23. A method of controlling an apparatus for producing electrolytic reduced water, the method comprising:
generating purified water by filtering water;
performing electrolysis on the purified water by applying different polarities of electricity to a first electrode and a second electrode, respectively;
storing reduced water, which is generated through the electrolysis, in a water storage unit;
detecting a water quality of the reduced water stored in the water storage unit;
determining a point of time for switching polarities of electricity applied to the first electrode and the second electrode based on the water quality; and
if it is determined that the point of time for switching the polarities of electricity is reached, switching the polarities of electricity applied to the first electrode and the second electrode by controlling an operation of a power supply unit.

24. The method of claim 23, wherein the performing the electrolysis comprises:
supplying some of the purified water to one of a first chamber and a second chamber on which the first electrode and the second electrode are disposed respectively; and
supplying the remaining to an ion exchange resin disposed between the first electrode and the second electrode.

25. The method of claim 24, wherein the supplying of some of the purified water to one of the first chamber and the second chamber comprises:
controlling a first valve configured to open/close passages connected to the first chamber and the second chamber, respectively, wherein a passage of a chamber to generate the reduced water is opened between the first chamber and the second chamber such that the some of the purified water is supplied and a passage of a chamber to generate oxygen gas is closed between the first chamber and the second chamber such that the supply of the purified water is blocked.

26. The method of claim 25, wherein further comprising switching a passage opened by the first valve between the passages if it is determined that the point of time for switching the polarities of electricity applied to the first electrode and the second electrode is reached.

27. The method of claim 25, further comprising:
detecting a flow rate of purified water discharged from a water purifying unit;
calculating an accumulated total of flow rate based on the detected flow rate;
switching polarities of the first electrode and the second electrode if the accumulated total of flow rate exceeds a reference flow rate; and
performing control such that a passage opened by the first valve is switched between the passages.

28. The method of claim 23, wherein the detecting of the water quality comprises detecting at least one data of a hydrogen ion concentration and an oxidation reduction potential (ORP).

29. The method of claim 28, wherein the determining of the point of time for switching the polarities of electricity applied to the first electrode and the second electrode based on the water quality comprises switching the polarities of the first electrode and the second electrode if the detected hydrogen ion concentration exceeds a reference level of hydrogen ion concentration.

30. The method of claim 28, wherein the determining of the point of time for switching the polarities of electricity applied to the first electrode and the second electrode based on the water quality comprises switching the polarities of the first electrode and the second electrode if the detected ORP exceeds a reference level of ORP.

31. The method of claim 23, further comprising:
detecting a water level of the reduced water stored in the water storage unit; and
controlling stopping of the electrolysis of the purified water if the detected water level exceeds a reference water level.

32. The method of claim 31, further comprising:
detecting the ORP of the reduced water if the detected water level exceeds the reference water level;
driving a pump provided between an electrolytic reduced water generating unit and the water storage unit if the detected ORP of the reduced water exceeds a reference ORP;
opening a divert valve provided between the pump and the electrolytic reduced water generating unit; and
receiving the reduced water of the water storage unit and performing electrolysis again, thereby recycling reduced water.

33. The method of claim 23, wherein the performing of the electrolysis comprises:
applying a constant electric current to the first electrode and the second electrode, and detecting voltages of the first electrode and the second electrode, and
controlling switching of the polarities of the first electrode and the second electrode if the detected voltage exceeds a reference voltage.

34. The method of claim 23, further comprising:
detecting a flow rate of the purified water; and
controlling a magnitude of electric current applied to the first electrode and the second electrode based on the detected flow rate.

35. The method of claim 23, wherein the performing of the electrolysis comprises:
applying a constant electric voltage to the first electrode and the second electrode, and detecting an electric current flowing between the first electrode and the second electrode, and
controlling a pulse-width modulation of the constant electric voltage if the detected electric current is below a reference electric current.

36. The method of claim 23, further comprising:
detecting a water level of the reduced water stored in the water storage unit;
detecting the ORP of the reduced water if the detected water level exceeds a predetermined reference water level;
opening a valve, which is connected to the water storage unit, to discharge the reduced water of the water storage unit to outside if the detected ORP of the reduced water exceeds a predetermined ORP that is designated in advance.
